(19) United States
(12) Patent Application Publication
(10) Pub. No.: US 2010/0246620 A1
(43) Pub. Date: Sep. 30, 2010

(54) LASER DEVICE

(75) Inventors: Hideki Maruyama, Kanagawa (JP); Kakushi Nakagawa, Kanagawa (JP); Keiji Nakazawa, Kanagawa (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SUMITOMO ELECTRIC DEVICE INNOVATIONS, INC., Yokohama (JP)

(21) Appl. No.: 12/730,874

(22) Filed: Mar. 24, 2010

(30) Foreign Application Priority Data
Mar. 25, 2009 (JP) 2009-074981
Mar. 4, 2010 (JP) 2010-047607

(51) Int. Cl. H01S 3/04; H01S 3/10

(52) U.S. Cl. 372/34; 372/38.02

(57) ABSTRACT

A laser device includes: an optical modulator that is optically coupled to a semiconductor laser mounted on a first mounting portion; a second mounting portion that is separately away from the first mounting portion; a bridge that couples the first mounting portion and the second mounting portion; a driver IC that is mounted on the second mounting portion and drives the optical modulator through a transmission pathway provided on the bridge; and a capacitor that is provided on the bridge and is coupled to the transmission pathway.

### CROSS-REFERENCE TO RELATED APPLICATION

This application is based upon and claims the benefit of priority of the prior Japanese Patent Application No. 2009-074981, filed on Mar. 25, 2009 and Japanese Patent Application No. 2010-047607, filed on Mar. 4, 2010, the entire contents of which are incorporated herein by reference.

### BACKGROUND

(i) Technical Field

The present invention relates to a laser device having a semiconductor laser.

(ii) Related Art

A laser device having a semiconductor laser and an optical modulator is known. A driver IC drives the optical modulator through a transmission pathway. Here, when an optical modulator requiring direct-current bias for driving is used, a capacitor is connected to the optical modulator in order to prevent inflow of the direct-current bias to the driver IC.

A direct-current cutting capacitor is susceptive to heat of a driver IC, and the property of the direct-current cutting capacitor gets variable, when the direct-current cutting capacitor is located near the driver IC. This may influence a signal transmitted to the optical modulator of the semiconductor laser. And, the modulation property may be degraded. Further, reliability may be degraded because of breaking of the capacitor.

### SUMMARY

It is an object of the present invention to provide a laser device having favorable modulation property.

According to an aspect of the present invention, there is provided a laser device including: an optical modulator that is optically coupled to a semiconductor laser mounted on a first mounting portion; a second mounting portion that is separately away from the first mounting portion; a bridge that couples the first mounting portion to the second mounting portion; a driver IC that is mounted on the second mounting portion and drives the optical modulator through a transmission pathway provided on the bridge; and a capacitor that is provided on the bridge and is coupled to the transmission pathway.

### BRIEF DESCRIPTION OF THE DRAWINGS

FIG. 1 illustrates a schematic top view of a laser device in accordance with a comparative example;

FIG. 2 illustrates a schematic top view of a laser device in accordance with a first embodiment;

FIG. 3 illustrates a schematic cross sectional view of the laser device in accordance with the first embodiment; and

FIG. 4 illustrates a schematic top view of a laser device in accordance with a second embodiment.

### DETAILED DESCRIPTION

A description will be given of a laser device in accordance with a comparative example, in order to state a problem to be solved by the following embodiment.

### Comparative Example

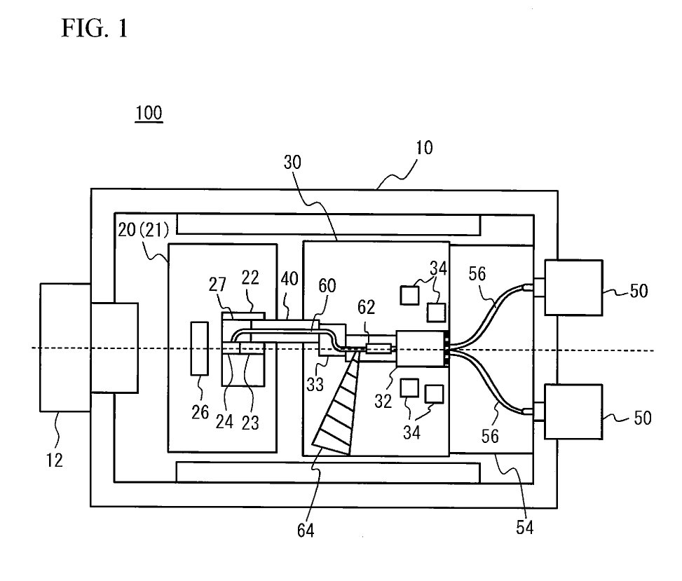

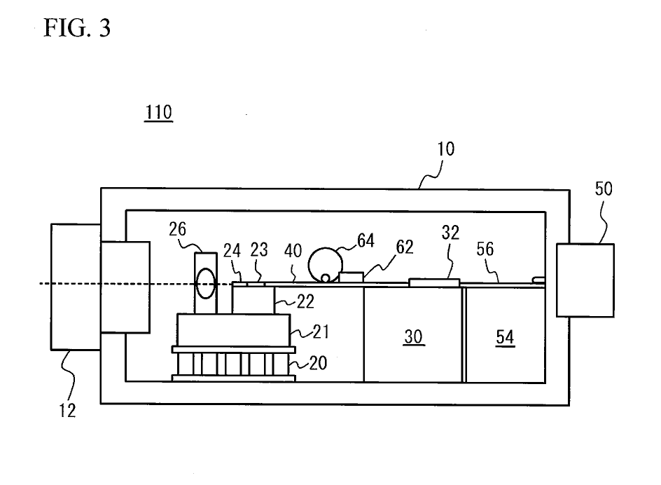

FIG. 1 illustrates a schematic top view of a laser device 100 in accordance with the comparative example. A package 10 houses a sub carrier 22 and a heat sink 30. A bridge 40 couples the sub carrier 22 to the heat sink 30. As illustrated in FIG. 3, there is a space under the bridge 40. A temperature control device 20 is separated away from the heat sink 30.

A carrier 21 is mounted on the temperature control device 20. The sub carrier 22 is mounted on the carrier 21. A semiconductor laser 23 and an optical modulator 24 are mounted on the sub carrier 22. The optical modulator 24 is optically coupled to the semiconductor laser 23, and modulates a light emitted from the semiconductor laser 23. A lens 26 is mounted on the carrier 21. The light emitted from the semiconductor laser 23 is modulated by the optical modulator 24, and is emitted from an outputting portion 12 of the package 10 through the lens 26. An optical axis of the light emitted from the semiconductor laser 23 to outside overlaps with a centerline of the package 10 in a width direction. That is, the semiconductor laser 23 is located on the centerline of the package 10 in the width direction.

A driver IC 32 for driving the optical modulator 24 is mounted on the heat sink 30. A plurality of noise cutting capacitors 34 are located on the heat sink 30 around the driver IC 32. The noise cutting capacitor 34 is coupled to a direct-current terminal of the driver IC 32 and removes a noise included in a signal fed into the driver IC 32. The signal fed into the driver IC 32 is provided from an external terminal 50. The external terminal 50 is coupled to the driver IC 32 through a transmission pathway 56 on a substrate 54. Two kinds of inputting signals are needed, because the driver IC 32 is driven with complementary signals. Therefore, the laser device 100 has two external terminals 50. The driver IC 32 is located on a center (a centerline of the package 10 in the width direction) of the two external terminals 50.

A transmission pathway 60 made of a MSL (Micro Strip Line) and so on couples the driver IC 32 to the optical modulator 24. The transmission pathway 60 is provided on a transmission pathway substrate 33 on the heat sink 30, on the bridge 40, and on a transmission pathway substrate 27 on the sub carrier 22. The transmission pathway 60 transmits a driving signal from the driver IC 32 to the optical modulator 24. A direct-current cutting capacitor 62 and a conical coil 64 are coupled to the transmission pathway 60 on the transmission pathway substrate 33 in order from the driver IC 32 side. The conical coil 64 provides a direct current carrying the signal from the driver IC 32 to the transmission pathway 60. The direct-current cutting capacitor 62 prevents inflow of the direct current provided from the conical coil 64 into the driver IC 32. A capacity of the direct-current cutting capacitor 62 is set so that the direct-current cutting capacitor 62 transmits the outputting signal of the driver IC 32.

The heat of the driver IC 32 causes relatively high temperature of the heat sink 30, in the laser device 100. The direct-current cutting capacitor 62 is susceptible to the heat from the heat sink 30, because the direct-current cutting capacitor 62 is mounted on the heat sink 30. Therefore, property of the direct-current cutting capacitor 62 gets variable. The direct-current cutting capacitor 62 has direct influence on a signal provided to the optical modulator 24, because the direct-current cutting capacitor 62 is coupled to the transmission pathway 60 from the driver IC 32 to the optical modulator 24. This may result in degradation of modulation property of the laser device 100.

As mentioned above, it is difficult to obtain favorable modulation property in the laser device 100 in accordance with the comparative example.

### First Embodiment

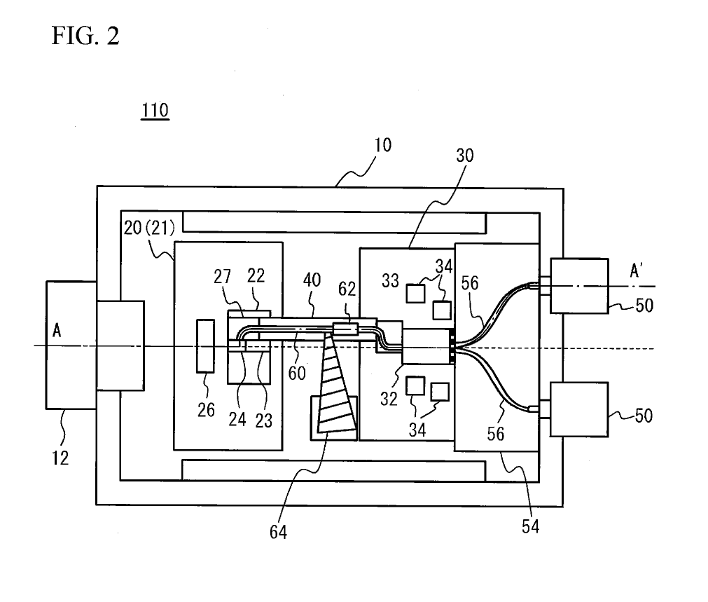

FIG. 2 illustrates a schematic top view of a laser device 110 in accordance with a first embodiment. FIG. 3 illustrates a cross sectional view taken along A-A′ dashed line of FIG. 2. The same components as those illustrated in FIG. 1 (the first comparative example) have the same reference numerals in order to avoid a duplicated explanation.

As illustrated in FIG. 2 and FIG. 3, the heat sink 30 is more downsized in the laser device 110 than in the comparative example. And, a distance between the temperature control device 20 and the heat sink 30 is enlarged. The bridge 40 couples the heat sink 30 to the sub carrier 22 on the temperature control device 20, as is the case with the comparative example. In the embodiment, the direct-current cutting capacitor 62 is mounted on the bridge 40 and is coupled to the transmission pathway 60 on the bridge 40 in series. The conical coil 64 is mounted on another carrier other than the heat sink 30 and is coupled to the transmission pathway 60 between the direct-current cutting capacitor 62 and the optical modulator 24. The other structure of the laser device 110 is the same as the comparative example.

Thermal conductance from the heat sink 30 to the direct-current cutting capacitor 62 is restrained, because in the laser device 110, the direct-current cutting capacitor 62 is mounted on the bridge 40. Therefore, property variability of the direct-current cutting capacitor 62 caused by heat generation of the driver IC 32 is restrained. Accordingly, the laser device 110 has favorable modulation property, because signal transmission from the driver IC 32 to the optical modulator 24 is improved. Breaking of the direct-current cutting capacitor 62 caused by the heat generation of the driver IC 32 is restrained. And, reliability degradation is restrained.

On the other hand, the other capacitors such as the noise cutting capacitor 34 are not coupled to the transmission pathway 60 between the driver IC 32 and the optical modulator 24, and have not so much influence on the modulation property of the laser device 110 even if a quantity of heat is generated in the driver IC 32. The capacitors may be mounted on the heat sink 30, as is the case with the comparative example. In other words, the direct-current cutting capacitor 62 connected to an alternating-current signal such as high frequency signal from the driver IC 32 is provided on the bridge 40, and the noise cutting capacitor 34 connected to a direct-current power supply is mounted on the heat sink 30. This allows an efficient arrangement of the capacitors having different purposes.

In the laser device 110, it is not necessary to generate a space for locating the direct-current cutting capacitor 62 and the conical coil 64 on the heat sink 30. Therefore, the heat sink 30 may be downsized. And a distance between the heat sink 30 and the temperature control device 20 may be enlarged. Therefore, thermal conduction from the heat sink 30 to the temperature control device 20 may be restrained. This allows reduction of power consumption of the temperature control device 20.

In the laser device 110, it is easy to exchange the direct-current cutting capacitor 62 and the conical coil 64. For example, in general, whole of a block of the transmission pathway 60, to which the direct-current cutting capacitor 62 and the conical coil 64 are coupled, is exchanged, when the direct-current cutting capacitor 62 and the conical coil 64 are to be exchanged by mistaking in mount processing. In the comparative example, it is necessary to exchange the transmission pathway substrate 33 on the heat sink 30. However, it is difficult to exchange the transmission pathway substrate 33 because all of a lower face of the transmission pathway substrate 33 is adhered to the heat sink 30 with brazing or the like. In contrast, a user only has to exchange the bridge 40. In the embodiment, only the end of the bridge 40 is connected to the temperature control device 20 and the heat sink 30 with brazing or the like. Therefore, it is easy to exchange the bridge 40, compared to exchanging of the transmission pathway substrate 33.

### Second Embodiment

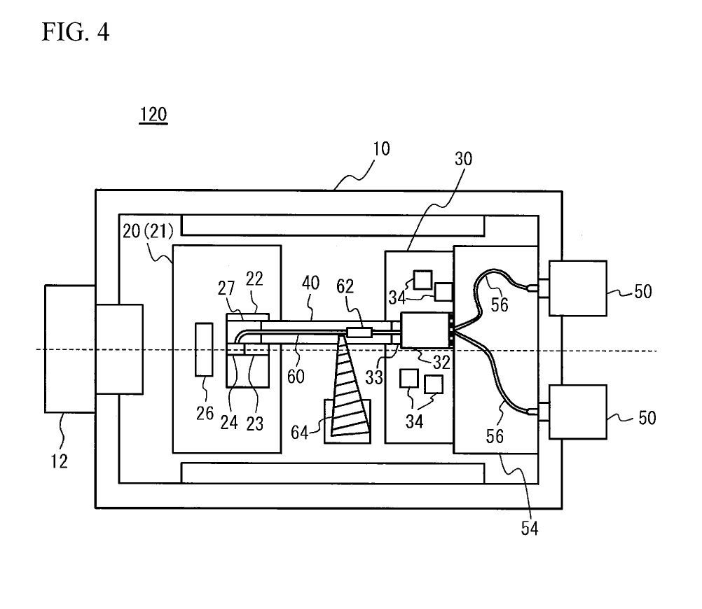

A second embodiment is an embodiment where the location of the driver IC 32 and the transmission pathway 60 is changed. FIG. 4 illustrates a schematic top view of a laser device 120 in accordance with the second embodiment. The same components as those illustrated in FIG. 2 (the first embodiment) have the same reference numerals in order to avoid a duplicated explanation.

In the laser device 110 in accordance with the first embodiment, the transmission pathway 60 is curved at the transmission pathway substrate 33 on the heat sink 30 side. In contrast, in the laser device 120 in accordance with the second embodiment, the transmission pathway 60 is not curved at the transmission pathway substrate 33. And, the driver IC 32 is located on a straight line in an extension direction of the transmission pathway 60 on the bridge 40. The semiconductor laser 23 and the optical modulator 24 are located on a centerline of the package 10 in the width direction, as is the case with the first embodiment. The bridge 40 and the transmission pathway 60 are located off the centerline in the width direction. The transmission pathway 60 is located on a straight line in parallel with the centerline of the package 10, on the bridge 40. The driver IC 32 is located on the straight line on the heat sink 30. Therefore, the driver IC 32 is located off the centerline in the width direction of the package 10. The two transmission pathways 56 coupling the driver IC 32 to the external terminal 50 have the same length.

In the laser device 120, the driver IC 32 is located on the straight line of the transmission pathway 60 on the bridge 40. It is therefore not necessary that the transmission pathway 60 is curved on the transmission pathway substrate 33. This allows downsizing of the heat sink 30. And, it is possible to enlarge the distance between the temperature control device 20 and the heat sink 30. Therefore, thermal isolation may be improved between the temperature control device 20 and the heat sink 30.

In the first and the second embodiments, the conical coil 64 is used as an inductor for providing direct-current to the transmission pathway 60. However, another inductor (for example, a coil having constant coil diameter) may be used.

The direct-current cutting capacitor 62 coupled to the transmission pathway 60 is mounted on the bridge 40. However, another capacitor may be mounted on the bridge 40. For example, if a capacitor for filtering may be coupled to a transmission pathway, thermal influence of the driver IC 32 is restrained when the capacitor is coupled to the transmission pathway 60 on the bridge 40. That is, thermal influence of a driver IC on a capacitor to be coupled to a transmission pathway is restrained when the capacitor is mounted on a bridge. This restrains degradation of high frequency wave caused by property changing of the capacitor.

The present invention is not limited to the specifically disclosed embodiments and variations but may include other embodiments and variations without departing from the scope of the present invention.

What is claimed is:

1. A laser device comprising:
an optical modulator that is optically coupled to a semiconductor laser mounted on a first mounting portion;
a second mounting portion that is separately away from the first mounting portion;
a bridge that couples the first mounting portion to the second mounting portion;
a driver IC that is mounted on the second mounting portion and drives the optical modulator through a transmission pathway provided on the bridge; and
a capacitor that is provided on the bridge and is coupled to the transmission pathway.

2. The laser device as claimed in claim 1 further comprising a noise cutting capacitor that is mounted on the second mounting portion and is coupled to the driver IC.

3. The laser device as claimed in claim 1, wherein a driving signal terminal of the driver IC is located on a straight line of the transmission pathway on the bridge.

4. The laser device as claimed in claim 1, wherein an inductor is coupled to the transmission pathway on the bridge.

5. The laser device as claimed in claim 1, wherein a region under the bridge is a hollow space.

6. The laser device as claimed in claim 4, wherein the inductor is a conical coil.

7. The laser device as claimed in claim 1, wherein the second mounting portion is a heat sink.

8. The laser device as claimed in claim 1, wherein the first mounting portion is located on a temperature control device.

9. The laser device as claimed in claim 8, wherein:
the first mounting portion is located on a carrier; and
the carrier is mounted on the temperature control device.

10. The laser device as claimed in claim 1, wherein the transmission pathway is composed of a micro strip line on the bridge.
